(19) United States
(12) Patent Application Publication
(10) Pub. No.: US 2011/0058269 A1
(43) Pub. Date: Mar. 10, 2011

(54) Inspecting Device

(76) Inventor: Chen-Chin SU, Dali City (TW)

(21) Appl. No.: 12/554,982

(22) Filed: Sep. 7, 2009

(51) Int. Cl. G02B 7/182

(52) U.S. Cl. 359/882

(57) ABSTRACT

An inspecting device is used in limited space. The inspecting device includes a mirror and a frame. The frame includes a back plate and a rim extending from the back plate and converging. Thus, the periphery of the mirror is firmly held with the rim of the frame. Moreover, a buffering space is defined between the periphery of the mirror and the rim of the frame.

### BACKGROUND OF INVENTION

1. Field of Invention

The present invention relates to an inspecting device for use in limited space.

2. Related Prior Art

Referring to FIG. 5, there is shown a conventional inspecting device for use in limited space. The conventional inspecting device includes a mirror 40, a back plate 41 and an adhesive layer 42 for attaching the mirror 40 to the back plate 41. The back plate 41 is connected to a shank operable to maneuver the mirror 40. Thus, the conventional inspecting device can be used to inspect the interior of a vehicle, machine or mouth. The conventional inspecting device however suffers some disadvantages. Firstly, the mirror 40 can easily be detached from the back plate 41 because of inadequate provision of the adhesive layer 42 or deterioration of the adhesive layer 42 caused by heat. Secondly, the mirror 40 can easily be damaged when it is used to inspect the interior of a vehicle or machine since the periphery of the mirror 40 is not protected.

The present invention is therefore intended to obviate or at least alleviate the problems encountered in prior art.

### SUMMARY OF INVENTION

It is an objective of the present invention to provide a reliable inspecting device.

It is another objective of the present invention to provide a robust inspecting device.

To achieve the foregoing objectives, the inspecting device includes a mirror and a frame. The frame includes a back plate and a rim extending from the back plate and converging. Thus, the periphery of the mirror is firmly held with the rim of the frame. Moreover, a buffering space is defined between the periphery of the mirror and the rim of the frame.

Other objectives, advantages and features of the present invention will become apparent from the following description referring to the attached drawings.

### BRIEF DESCRIPTION OF DRAWINGS

The present invention will be described via detailed illustration of two embodiments versus the prior art referring to the drawings.

FIG. 1 is an exploded view of an inspecting device according to the first embodiment of the present invention.

FIG. 2 is a partial, cross-sectional view of the inspecting device shown in FIG. 1.

FIG. 3 is a perspective view of an inspecting device according to the second embodiment of the present invention.

FIG. 4 is a perspective view of a handle connected to the inspecting device shown in FIG. 3.

FIG. 5 is a cross-sectional view of a conventional inspecting device.

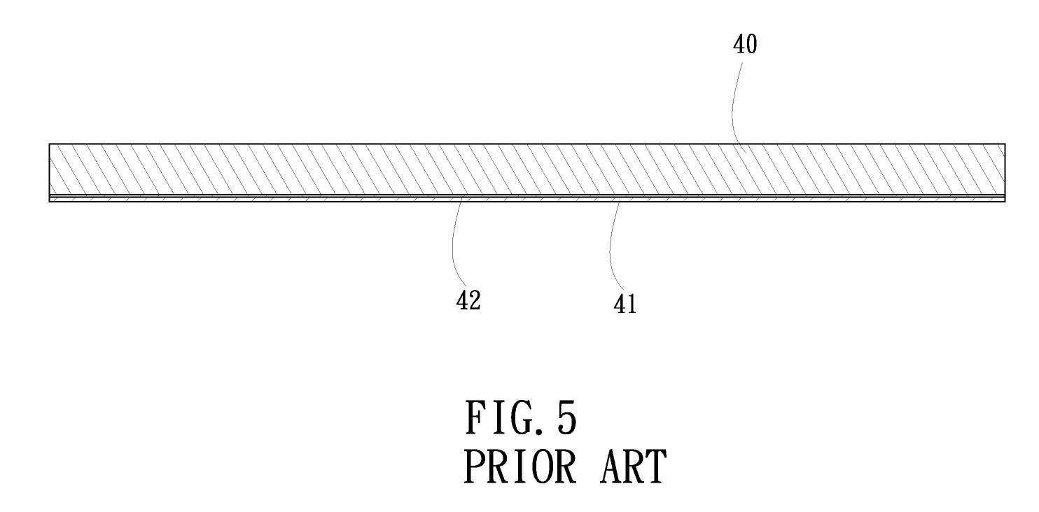

### DETAILED DESCRIPTION OF EMBODIMENTS

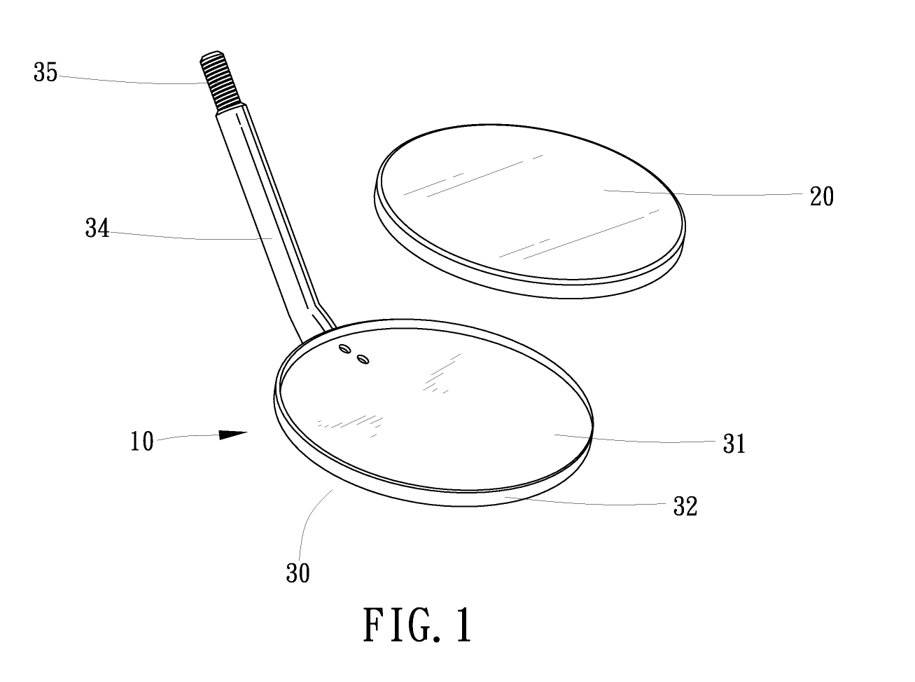

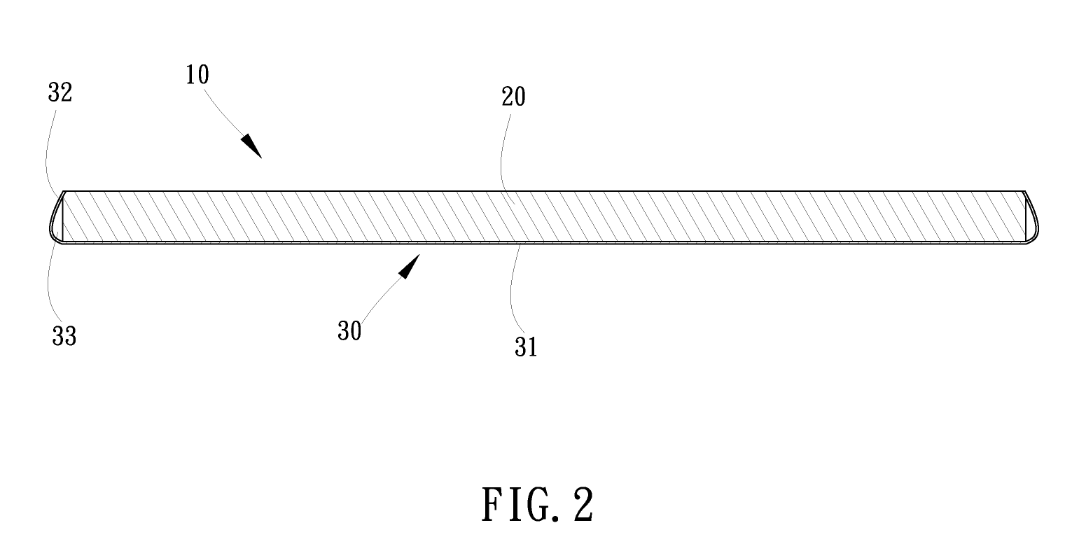

Referring to FIGS. 1 and 2, an inspecting device 10 includes a mirror 20, a frame 30 and a shank 34 according to a first embodiment of the present invention. The frame 30 includes a back plate 31 and a rim 32 formed on and around the back plate 31. The back plate 31 is shaped corresponding to the mirror 20. The area of the back plate 31 is larger than that of the mirror 20. The rim 32 extends from the back plate 31 and converges. Thus, the periphery of the mirror 20 is firmly held with the rim 32 of the frame 30. There is a buffering space 33 defined between the periphery of the mirror 20 and the rim 32 of the frame 30. The buffering space 33 is intended to protect the mirror 20 when the frame 30 is hit during operation.

The shank 34 is an angled element. An end of the shank 34 is connected to the back plate 31 of the frame 30 by welding or a rivet for example. Another end of the shank 34 is formed with a thread 35. The thread 35 of the shank 34 can be engaged with a thread formed on an internal side of a handle.

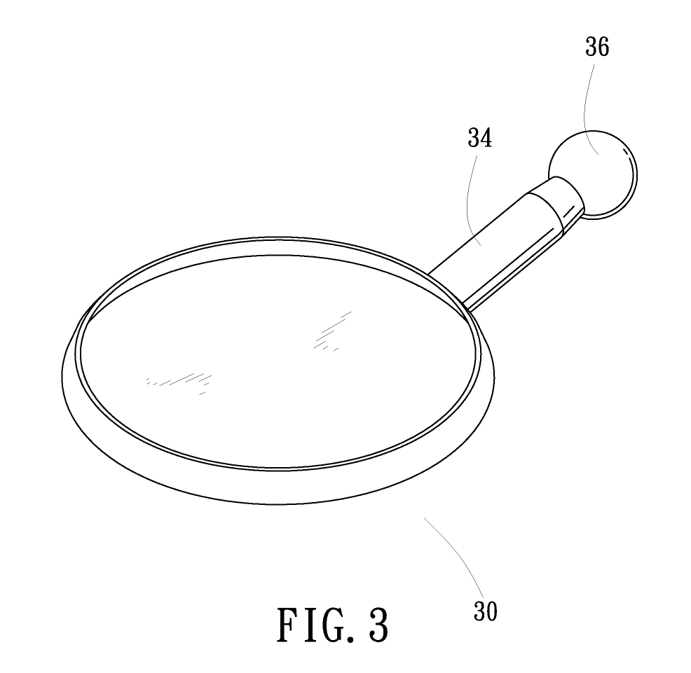

Referring to FIG. 3, there is shown an inspecting device according to a second embodiment of the present invention. The second embodiment is identical to the first embodiment except that the shank 34 is formed with a ball 36.

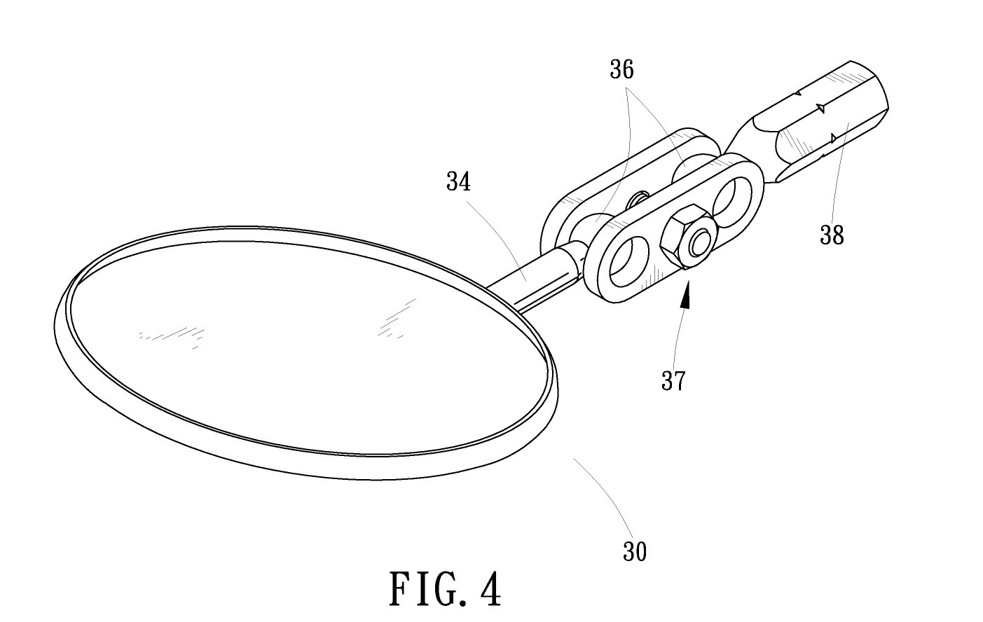

Referring to FIG. 4, a connecting unit 37 is used to connect the ball 36 of the inspecting device 10 to a ball 36 formed at an end of a handle 38. The connecting unit 37 includes a first strip, a second strip and a fastener for connecting the first strip to the second strip. Each of the first and second strips includes a first recess defined therein and a second recess defined therein. The ball 36 of the inspecting device 10 includes a portion disposed in the first recess of the first strip and another portion disposed in the first recess of the second strip. The ball 36 of the handle 38 includes a portion disposed in the second recess of the first strip and another portion disposed in the second recess of the second strip. Thus, the inspecting device 10 is pivotally connected to the handle 38. The connecting unit 37 can be replaced with a socket formed at an end of the handle 38.

The present invention has been described via the detailed illustration of the illustrated embodiments. Those skilled in the art can derive variations from the illustrated embodiments without departing from the scope of the present invention. Therefore, the illustrated embodiments shall not limit the scope of the present invention defined in the claims.

1. An inspecting device comprising:
a mirror; and
a frame comprising a back plate and a rim extending from the back plate and converging so that the periphery of the mirror is firmly held with the rim of the frame and that a buffering space is defined between the periphery of the mirror and the rim of the frame.

2. The inspecting device according to claim 1 comprising a shank connected to the back plate of the frame.

3. The inspecting device according to claim 2, wherein the shank comprises a thread formed at an end for engagement with a thread formed on an internal side of a handle.

4. The inspecting device according to claim 2 comprising a connecting unit, wherein the shank is formed with a ball connected to a ball formed on a handle via the connecting unit.

5. The inspecting device according to claim 2, wherein the shank comprises a ball formed at an end for insertion in a socket formed on a handle.
